(19) United States
(12) Patent Application Publication
(10) Pub. No.: US 2002/0136610 A1
(43) Pub. Date: Sep. 26, 2002

(54) Tool for material-removing machining of workpieces

(76) Inventor: Dieter Kress, Aalen (DE)

Correspondence Address: MORRISS, BATEMAN, O'BRYANT & COMPAGNI, 136 SOUTH MAIN STREET, SUITE 700, SALT LAKE CITY, UT, 84101, US

(21) Appl. No.: 10/099,501

(22) Filed: Mar. 15, 2002

(30) Foreign Application Priority Data
Mar. 22, 2001 (DE) 10114747.3

(51) Int. Cl. B23B 27/14; B23P 15/30

(52) U.S. Cl. 407/35; 407/118

(57) ABSTRACT

A tool for material-removing machining of workpieces is proposed that has at least one blade plate having an active cutter, which blade plate can be firmly mounted on the tool by means of a clamping lug. The tool is distinguished in that the blade plate (1; 1′) on its side edge (25) opposite the active cutter (13) has a wedge-shaped shoulder (27) which-starting from the front side (15) of the blade plate (1; 1′) on which lies the clamping lug (37)-broadens in the direction of the back side (29).

### DESCRIPTION

The invention concerns a tool for material-removing machining of workpieces. Tools of the type referred to here are known. They have at least one blade which are [sic] tightly fixed to the tool by means of a clamping lug so that a portion of the blade plate extends beyond the circumferential surface of the tool and is available as a blade for removal of chips. In this process, either the workpiece is moved past the stationary tool or the tool is caused to rotate and is brought into contact with the workpiece.

In particular in the case of the use of blade plates which are equipped with polycrystalline diamond PCD or cubic boron nitride CBN, a certain thickness of blade plates is needed in order to ensure a good hold of the insert in the blade plate. In particular in the case of small tool diameters and in tools on whose periphery several blades are to be mounted, this leads to space problems. It was found that in some application cases, the contact surface between the blade plate and the tool is so small that a secure hold on the blade plate no longer can be ensured. Thus it is possible that the blade plate becomes displaced from the specified position and may break off, so that parts of the blade plate flying about represent a danger, or at a minimum can result in damage to the workpiece or the tool.

### SUMMARY OF THE INVENTION

The task of the invention therefore is to create a tool of the type mentioned which does not have this drawback.

To solve this task, a tool is proposed which has the features mentioned in the claims. It is characterized in that the blade plate on its side edge opposite the active cutting edge has a wedge-shaped shoulder. This [shoulder] expands-moving out from the front side of the blade plate-in the direction toward its back side on which it fits. In this manner it is possible to enlarge the contact surface between blade plate and tool so that a more reliable hold is ensured.

An exemplary embodiment of the tool is preferred which is distinguished in that the blade plate-seen in side view-is configured essentially as a parallelogram. Thus it is possible to configure the blade plate as a so-called turning plate and to equip it with two cutting edges. If an active cutting edge projecting beyond the circumferential surface has become dull, it is possible to rotate the blade plate by 180° around a rotation axis which is vertical to the side edge and to bring the cutting edge situated opposite the active cutting edge now in contact with a workpiece. Additional advantages can be found in the other subclaims.

### BRIEF DESCRIPTION OF THE DRAWINGS

The invention will be explained in greater detail using the drawings.

FIG. 1 shows a top view of the front side of a blade plate;

FIG. 2 shows a view of the face of the blade plate;

FIG. 3 shows a schematic diagram of a clamping lug that is configured as a turning plate.

### DETAILED DESCRIPTION

The blade plate 1 depicted in FIG. 1 in this case is configured essentially as a rectangle. In the area of the right upper edge, blade plate 1 was ground so that a step 3 is formed which receives a cutter insert 5. The cutter insert is preferably firmly soldered in the area of step 3 and consists of PCD or CBN, in particular of a very wear-resistant material in order to ensure high wear resistance of blade plate 1.

Cutter insert 5 extends to face side 7 of blade plate 1 which here forms a right limiting edge of blade plate 1. Cutter insert 5 is provided in direction of face side 7 with a dropping edge 9 that transitions into an essentially horizontally oriented section 11. The intersection between section 11 and edge 9 represents the active cutting edge 13, with dropping areas in the direction of face side 7 forming the primary cutting edge and horizontal or in particular areas of section 11 dropping in opposite direction form the minor cutting edge.

In the front side 15 of blade plate 1, a groove is fabricated which inclines at acute angle of preferably 10° from bottom to top into the plane of the figure and thus has an edge on which a clamping lug rests.

Between front side 15 and step 3 there is an edge 19 that drops at an acute angle from left to right in the direction toward face side 7. Thus it is possible to realize an acute angle even in the area of flank 9 so that the main cutting edge has a very flat and long lead angle.

It can be seen in FIG. 1 that the basic material of blade plate 1 in the area of active cutting edge 13 is completely replaced by cutter insert 5 consisting of hard material.

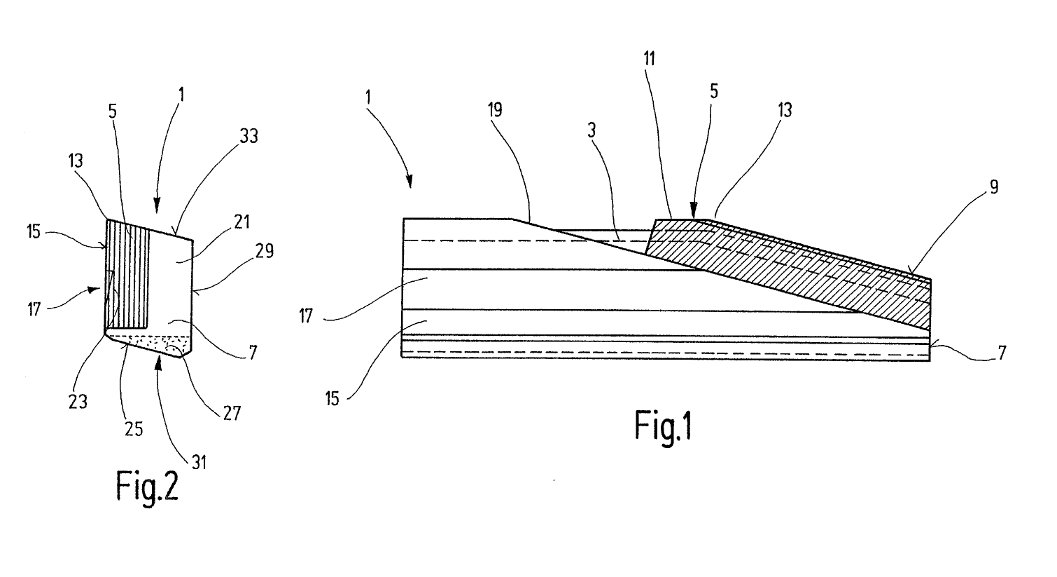

Blade plate 1 in the depiction in FIG. 2 shows its face side 7. Cutter insert 5 is contrasted from the rest of base body 21 of blade plate 1 through parallel lines. From the side view per FIG. 2, the slightly dropping edge 23 of groove 17 can be seen.

From the depiction per FIG. 2, it can also be seen that the blade plate on its side edge 25 opposite active cutter 13 has a wedge-shaped shoulder 27, emphasized here through dots, which extends-beginning from front side 15 of blade plate 1-in the direction toward the back side 29 of the blade plate. Shoulder 27 thus forms a contact surface 31 with which blade plate 1 in fastened condition rests upon a support for example on an adjusting device with the help of which the projection of active cutter 13 over the circumferential surface of the associated tool can be adjusted.

From the side view of blade plate 1 it finally can be seen that on the one hand front side 15 runs parallel with back side 29, but that also the upper side 33 runs parallel with lower side edge 25. Upper side 33 and side edge 25 enclose an obtuse angle with the front or rear side of blade plate 1 so that face side 7 of blade plate 1 for practical purposes is configured as a parallelogram.

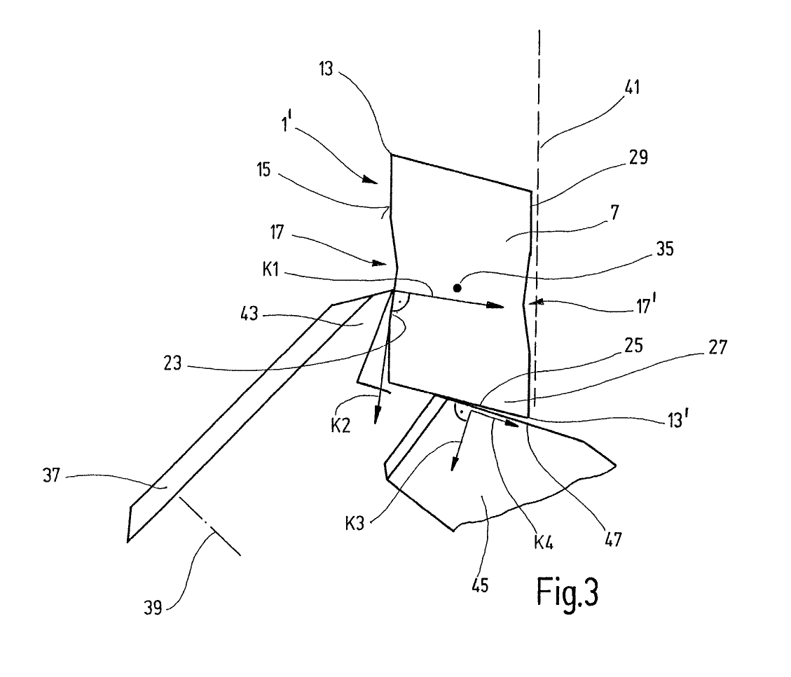

The schematic diagram according to FIG. 3 shows a further exemplary embodiment of a blade plate 1′, the face side 7 of which directed toward the observer is in like manner configured as a parallelogram. In the depiction according to FIG. 3, blade plate 1′ is reflected in a position as is also depicted in FIG. 2. Like parts are provided with like reference numbers, so that to this extent the explanations for FIG. 2 can be referenced.

The exemplary embodiment depicted in FIG. 3 is distinguished in that on the one hand a groove 17 is provided on its front side 15, but that in addition another groove 17′ is provided on its back side 29. In the exemplary embodiment of blade plate 1′ depicted in FIG. 3′, grooves 17 and 17′ are configured as V-shapes, with the edges of grooves 17, 17′ being arranged in an acute angle of approximately 10° in relation to the front and rear sides, respectively.

The upper left edge of blade plate 1′, which extends over the circumferential surface of the tool, serves here again as active cutter 13 with which chips can be removed from a workpiece. The exemplary embodiment of blade plate 1′ depicted here is configured as a turning plate. That is, on the diametrically opposite side of the blade plate there is an additional cutter 13′ which upon a rotation of blade plate 1′ around a longitudinal axis vertical to face side 7 which is suggested through a point 35, projects over the circumferential surface of the tool and can be brought into contact with a tool.

In FIG. 3′, a clamping lug 37 is suggested which can be fastened to the base body of the tool by means of a clamping screw, which here is suggested only through a dash-dotted line 39, in order to press the rear side 29 of the blade plate firmly against a bearing surface which is configured on the base body of the tool and is suggested here by a dashed line 41.

Clamping lug 37 rests with a clamping lip 43 on front side 15 of blade plate 1′, specifically on gently declining edge 23 of groove 17. Edge 23 causes a distribution of the forces exerted by clamping lip 43 on blade plate 1′: A first force component K1 is vertical to edge 23 and thus acts in the direction toward the feed surface suggested by line 41. A second component K2, which again is suggested by an arrow, runs in the plane of edge 23.

Side edge 25 of blade plate 1′ opposite active cutter 13 rests on a support in this case on at least one adjusting wedge 45 which is a part of the adjusting device and serves to adjust the overhang of active cutter 13 over the circumferential surface of the tool and thus its processing diameter.

Adjusting wedge 45 has a bearing surface 47 which runs essentially parallel to side edge 25. Downwardly directed force component K2 caused by clamping lip 43 splits in turn in the area of bearing surface 47, with a first force component K3 being vertical to bearing surface 47 and a second force component K4 essentially running in bearing surface 47. Force component K4 causes the underside of blade plate 1 opposite active cutter 13 to be pressed with a defined force K4 against bearing surface suggested by line 41.

The splitting of forces in the area of bearing surface 47 is achieved in that blade plate 1′ has a shoulder 27 through bearing plate 1′ being broaden toward the bottom which leads to a clearly enlarged bearing surface in the area of back side 29 of blade plate 1′.

The schematic diagram according to FIG. 3 thus clearly shows that blade plate 1 explained with the help of FIGS. 1 through 3 as a result of shoulder 27 is impacted in the area of its side edge opposite active cutter 13 by force component K4 which brings about a reliable anchoring of blade plate 1 or 1′ in the tool. This is also the case if blade plate 1′ or 1 rests on a stationary support, i.e., if in place of adjusting wedge 45 a diagonal bearing surface is made available for blade plate 1 or 1′.

From the explanations for the figures it is clear that the improved mounting possibility of the blade plate is also present if cutter insert 5, as it was explained with the aid of FIGS. 1 and 2, is omitted. But it can also be seen that through shoulder 27 of blade plate 1, 1′ additional material is available which facilitates the mounting of a cutter insert 5 even in the case of blade plates 1, 1′ of small dimensions.

If blade plate 1′, as it is explained with the aid of FIG. 3, is provided with two grooves 17 and 17′, it is possible to realize a turning plate which in the event of wear of active cutter 13 can be rotated around a longitudinal axis suggested in FIG. 3 by a point 35 in order to make available undamaged cutter 13′ in the event of active cutter 13, for further machining of a workpiece.

Grooves 17, 17′, discussed with the aid of the figures, do not have to extend over the entire width of blade plate 1, 1′. It is possible, for example, for a web to be provided to the right and the left which terminates the groove and prevents, or at least makes difficult, the penetration of chips or other foreign bodies between clamping lug 37 and front side 15 of blade plate 1, 1′.

1. Tool for material-removing machining of workpieces, with at least one blade plate having an active cutter, which blade plate can be firmly mounted on the tool by means of a clamping lug, characterized in that the blade plate (1; 1′) has on its side edge (25) opposite the active cutter (13) a wedge-shaped shoulder (27) which spreads-beginning from the front side (15) of the blade plate (1; 1′), on which the clamping lug (37) rests-in the direction toward the back side (29).

2. Tool according to claim 1 characterized in that the blade plate (1; 1′)-viewed from the side-is configured essentially in the shape of a parallelogram.

3. Tool according to claim 1 or 2 characterized in that the blade plate (1; 1′) in addition is configured as a turning plate and has two cutters (13, 13′) situated-view from the side-diametrically opposite.

4. Tool according to one of the preceding claims characterized in that the blade plate (1; 1′) has a groove (17) on its front side (15)

5. Tool according to one of the preceding claims characterized in that the blade plate (1′) has a groove (17′) on its back side (29).

6. Blade plate [sic] according to claim 4 or 5 characterized in that the groove (17, 17′) does not extend over the entire width of the blade plate (1; 1′).
